(19) United States
(12) Patent Application Publication
(10) Pub. No.: US 2004/0048940 A1
(43) Pub. Date: Mar. 11, 2004

(54) Flexible polyurethane foams inhibited from yellowing and pad

(76) Inventors: Hideya Kinoshita, Yokohama (JP); Noriyuki Yamaguchi, Yokohama (JP)

Correspondence Address: SUGHRUE MION, PLLC, 2100 PENNSYLVANIA AVENUE, N.W., WASHINGTON, DC, 20037, US

(21) Appl. No.: 10/451,012

(22) PCT Filed: Aug. 10, 2001
(86) PCT No.: PCT/JP01/06969

(30) Foreign Application Priority Data
Dec. 27, 2000 (JP) 2000-398229
Jul. 13, 2001 (JP) 2001-214034

(51) Int. Cl. C08G 18/00

(52) U.S. Cl. 521/155

(57) ABSTRACT

A slow-yellowing flexible polyurethane foam which is prevented from being subject to yellowing the foam itself and color migration due to the yellowing is provided without using expensive aliphatic isocyanate as the isocyanate component in raw material. A slow-yellowing flexible polyurethane foam which is made by foaming a polyurethane raw material containing a polyol component and an isocyanate, wherein the polyol component contains a polyether polyol having ester bonds in the polyol backbone. A slow-yellowing flexible polyurethane foam which is made by foaming a polyurethane raw material containing a polyol component and an isocyanate, wherein the polyol component contains a polyether polyol having a plurality of benzene rings in the polyol structure. A slow-yellowing flexible polyurethane foam which is made by foaming a polyurethane raw material containing a polyol component and an isocyanate, wherein the polyol component contains a polyether polyol having ester bonds in the polyol backbone and having a plurality of benzene rings in the polyol structure.

### CROSS REFERENCE TO RELATED APPLICATION

This is a continuation application of PCT/JP01/06969 filed on Aug. 10, 2001.

### FIELD OF THE INVENTION

The present invention relates to a slow-yellowing flexible polyurethane foam and, more particularly, to an slow-yellowing flexible polyurethane foam which is useful as pads for clothing-related uses such as brassiere pads, shoulder pads, and hanger pads, material for sanitary goods such as disposable diapers and napkins, and material for medical-related goods and miscellaneous goods. The present invention also relates to a pad or brassiere pad made of the slow-yellowing flexible polyurethane foam.

### BACKGROUND OF THE INVENTION

Flexible polyurethane foams have good cushioning properties and, differently from cotton, do not loose their elasticity and have a soft and good feel even after being used for a long time or repeatedly. Therefore they have been widely used as pads for clothing-related uses such as brassiere pads, shoulder pads, and hanger pads, material for sanitary goods such as disposable diapers and napkins, and material for medical-related goods and miscellaneous goods.

Conventional flexible polyurethane foams have been made of a polyol raw material which contains BHT (dibutyl cresol) as an antioxidant. Therefore, there are problems due to the BHT, such as discoloration (yellowing) of the foam itself or color migration (the cloth in contact with the flexible polyurethane foam is stained). That is, when a raw material composition containing BHT is foamed to produce a flexible polyurethane foam, BHT remains in the foam after the foaming step and reacts with nitrogen oxides (NOₓ) contained in the atmosphere to yellow the urethane foam itself. Since BHT has ability to sublime, it evaporates and adheres to cloth nearby to discolor the cloth likewise.

The flexible polyurethane foam causes yellowing by the effects of ultraviolet rays too. [0006] Such yellowing and color migration of the foam should be a serious defect of a flexible polyurethane foam for clothing-related uses, medical-related goods, and daily goods such as miscellaneous goods.

For preventing the yellowing of foams, conventionally, a polyol component containing polypropylene glycol (PPG) as its main component is used as polyurethane raw material and an ultraviolet absorbent and an anti-NOₓ agent (agent for inhibiting the reaction with NOₓ) are added to the polyol component, thereby retarding the discoloration due to ultraviolet rays and the discoloration due to the reaction with NOₓ. In addition, the amount of antioxidant having high volatizing property such as BHT is reduced or such antioxidant is not used, thus also preventing the discoloration.

As an alternative method, an aliphatic isocyanate which is effective for preventing yellowing is used as isocyanate component of polyurethane raw material.

However, even if the ultraviolet absorbent and the anti-NOₓ agent are added to the polyurethane raw material or the use of antioxidant having high volatizing property such as BHT is limited, the yellowing can not be inhibited sufficiently.

Though the use of aliphatic isocyanate can provide an effect of inhibiting the yellowing, there are problems that the cost of foams is increased because the aliphatic isocyanate is expensive and that the obtained foam has poor durability against heat and humidity.

As mentioned above, at present, any economical and effective technology for preventing yellowing has not been provided. On the other hand, NOₓ exists in the atmosphere and it is impossible to completely shield against NOₓ. Therefore, it is strongly desired to provide a measure to such yellowing of foams due to NOₓ and color migration due to the yellowing.

### DISCLOSURE OF THE INVENTION

It is a first object of the present invention to provide a slow-yellowing flexible polyurethane foam which is prevented from being subject to yellowing the foam itself and color migration due to the yellowing without using expensive aliphatic isocyanate as the isocyanate component in raw material.

It is a second object of the present invention to provide a pad made of the slow-yellowing flexible polyurethane foam.

A slow-yellowing flexible polyurethane foam of the first invention is a polyurethane foam which is made by foaming a polyurethane raw material containing a polyol component and an isocyanate and is characterized in that the polyol component contains a polyether polyol having ester bonds in the polyol backbone.

A slow-yellowing flexible polyurethane foam of the second invention is a polyurethane foam which is made by foaming a polyurethane raw material containing a polyol component and an isocyanate and is characterized in that the polyol component contains a polyether polyol having a plurality of benzene rings in the polyol structure.

A slow-yellowing flexible polyurethane foam of the third invention is a polyurethane foam which is made by foaming a polyurethane raw material containing a polyol component and an isocyanate and is characterized in that the polyol component contains a polyether polyol having ester bonds in the polyol backbone and having a plurality of benzene rings in the polyol structure.

The polyurethane foam which is made by the reaction of the aforementioned polyol component with the isocyanate can be prevented from being subject to yellowing of the foam itself and the color migration due to the yellowing even when a cheap tolylene diisocyanate is employed as the isocyanate in the raw material.

In the present invention, the polyether polyol is preferably a phthalic acid-based polyether polyol.

The polyether polyol used in the present invention may contain a non-volatile antioxidant having a molecular weight of 300 or more.

Further, the polyurethane raw material may contain an ultraviolet absorbent and/or an anti-NOₓ agent.

A pad of the present invention is made of the aforementioned slow-yellowing flexible polyurethane foam of the present invention.

A brassiere pad of the present invention is made of the aforementioned slow-yellowing flexible polyurethane foam of the present invention.

### BRIEF DESCRIPTION OF THE DRAWINGS

FIG. 1 is a sectional view showing a mold used in examples.

### DETAILED DESCRIPTION OF THE PREFERRED EMBODIMENTS

In a slow-yellowing flexible polyurethane foam of the present invention, used as a polyol component in the polyurethane raw material is:

(i) polyether polyol having ester bonds in the polyol backbone;

(ii) polyether polyol having a plurality of benzene rings in the polyol structure; or

(iii) polyether polyol having ester bonds in the polyol backbone and having a plurality of benzene rings in the polyol structure.

Examples of these polyether polyols include phthalic acid-based polyether polyols and maleic acid-based polyether polyols. Employed as such phthalic acid-based polyether polyol may be a polyether polyol which is prepared by alternatively adding propylene oxide and phthalic anhydride into glycerin to have ends with propylene oxide. The content of phthalic acid in the phthalic acid-based polyether polyol is preferably from 50 to 70 percent by weight.

In the present invention, the polyol component may also contain polyol(s) other than the aforementioned polyols (i), (ii), and (iii) within such a range not to loose the effect of the present invention.

The polyol other than the aforementioned polyols may be a polyether polyol which is prepared by adding propylene oxide or ethylene oxide into glycerin, trimethylol propane or diethylene glycol to polymerize them, or a polyether polyol which is prepared by adding adipic acid into diethylene glycol, trimethylol propane or glycerin to polymerize them.

The polyol component as the raw material of making the polyurethane foam of the present invention preferably contains one of the aforementioned polyether polyols (i), (ii), and (iii) in an amount of from 10 to 100 percent by weight, more preferably from 50 to 100 percent by weight of the entire polyol component. When the content is less than 10 percent by weight, the yellowing of the obtained polyurethane foam can not be sufficiently prevented.

The polyol component may contain a non-volatile antioxidant having a high molecular weight. As the antioxidant, a high polymer phenolic antioxidant having a molecular weight of 300 or more is preferably used.

When a phenolic antioxidant has a molecular weight less than 300, the antioxidant volatizes, leading to the occurrence of color migration. The molecular weight of the phenolic antioxidant is preferably 400 or more, particularly 600 or more. Commercially-available examples of the phenolic antioxidant are “Naugard 445” available from Uniroyal Chemical Company or “AO80” available from Asahi Denka Co., Ltd.

When the blending amount of the phenolic antioxidant is too small, the oxidation inhibiting property should be poor. On the other hand, when it is too large, the obtained foam may have defective appearance. Accordingly, the blending amount of the phenolic antioxidant is preferably in a range from 0.05 to 2.0 parts by weight per 100 parts by weight of the polyol component.

It is preferable that the polyol component is substantially free from BHT.

The slow-yellowing flexible polyurethane foam of the present invention can be produced from an ordinary polyurethane raw material as follows, according to a conventional process such as the following method, except that one of the aforementioned polyether polyols (i), (ii), (iii) is used as the polyol component. The NCO index of the polyurethane raw material is preferably from 90 to 120.

<Polyurethane Raw Material Composition (Parts by Weight)>

Polyol component: 100

Isocyanate component: 80-120 (NCO index)

Catalyst: 0.01-2.0

Foaming agent: 1.0-25.0

Foam stabilizer: 0.1-3.0

The isocyanate component may be an organic polyisocyanate having two or more isocyanate groups per molecule, including aliphatic and aromatic polyisocyanate compounds and their modified compounds, but not limited thereto. Examples of the aliphatic polyisocyanate include hexamethylene diisocyanate, isophorone diisocyanate, dicyclohexylmethane diisocyanate, and methylcyclohexane diisocyanate. Examples of the aromatic polyisocyanate include toluene diisocyanate, diphenylmethane diisocyanate, and polymeric diphenylmethane diisocyanate. Examples of their modified compounds include carbodiimide modified compounds and prepolymer modified compounds. Polyisocyanates preferably employed in the present invention are aromatic polyisocyanates or modified compounds of aromatic polyisocyanates, especially, toluene diisocyanate, and diphenylmethane diisocyanate.

As for the foaming agent, any foaming agent which can be used for production of polyurethane foams can be used. Examples of the foaming agent include chlorofluorocarbon compounds such as trichlorofluoromethane and dichlorodifluoromethane as a low boiling point inactive solvent, methylene chloride, water, acid amides and nitroalkanes as a substance which generates gas by liquefied carbon dioxide gas reaction, sodium bicarbonate and ammonium carbonate as a substance which generates a gas by heat decomposition. Among these, methylene chloride and water are preferably employed as the foaming agent.

As a catalyst, any catalyst which can be ordinarily used for production of urethane foams can be used. Examples of the catalyst include tin type catalysts such as dibutyltin dilaurate, stannous octoate, and tertiary amines such as triethylamine and tetramethyl hexanemethylenediamine.

In the present invention, a surfactant, a flame retardant and/or other assistants may be added in the polyurethane raw material if necessary. As the surfactant, a silicone type surfactant can be employed. Examples of the flame retardant include organic powder of urea or thiourea, and inorganic powder of a metal hydroxide or antimony trioxide, in addition to the conventionally known flame retardant such as tris (2-chloroethyl) phosphate, and tris (2,3-dibromopropyl) phosphate.

Examples of other assistants include coloring powder such as a pigment and dye, powder of talc or graphite, glass short fiber, and other inorganic fillers, and an organic solvent.

In the present invention, the polyurethane raw material contains at least one of an ultraviolet absorbent and an anti-NOₓ agent, thereby further securely preventing the yellowing of obtained polyurethane foams.

The ultraviolet absorbent preferably employed in the present invention is a benzotriazole type ultraviolet absorbent capable of preventing the yellowing due to ultraviolet rays. Commercially-available examples of the benzotriazole type ultraviolet absorbent are “T-213” available from Ciba-Geigy, Ltd and “LA-31” available from Asahi Denka Co., Ltd.

When the blending amount of the benzotriazole type ultraviolet absorbent is too large, the obtained foam may have defective appearance. Accordingly, the blending amount of the benzotriazole type ultraviolet absorbent is preferably from 0.1 to 3.0 parts by weight per 100 parts by weight of the polyol component in the polyurethane raw material.

The anti-NOₓ agent preferably employed in the present invention is a phosphorus type antioxidant capable of preventing the discoloration of polyurethane foams due to NOₓ or the discoloration due to hot press. Commercially-available examples of the phosphorus type antioxidant are “3010” and “1178” available from Adeka Co., Ltd. When the blending amount of the phosphorus type antioxidant is too large, the obtained foam may have defective appearance. Accordingly, the amount of the phosphorus type antioxidant is preferably from 0.5 to 6.0 parts by weight per 100 parts by weight of the polyol component in the polyurethane raw material.

The slow-yellowing flexible polyurethane foam of the present invention is preferably produced to have a foam density of the order of 12-80 kg/m³.

The slow-yellowing flexible polyurethane foam of the present invention can be shaped into a product having a desired configuration even by hot press at a relatively low temperature and a relatively short period of time. Examples of the product include pads for clothing-related uses such as brassiere pads, shoulder pads, and hanger pads. Among these, the slow-yellowing flexible polyurethane foam is suitably applied to brassiere pads. To form pads from the slow-yellowing flexible polyurethane foam of the present invention, a foam block having a predetermined size is hot-pressed between an upper part and a lower part of a mold.

The pad may be directly used as a brassier pad, a sholder pad, a hanger pad, or the like and may be wrapped by a cloth. Though the cloth may be woven fabric or nonwoven fabric, woven fabric is preferable. Material of the cloth may be natural fibers such as cotton or chemical fibers such as nylon and polyester.

Since the slow-yellowing flexible polyurethane foam of the present invention is hardly discolored, the pad product wrapped with the cloth should never be discolored for a long period of time even when the cloth can be thin so that the slow-yellowing flexible polyurethane foam inside the cloth can be seen through the cloth.

The present invention will be concretely described by the following examples and comparative examples.

### EXAMPLE 1 AND COMPARATIVE EXAMPLES 1, 2

Polyurethane raw materials having the compositions shown in Table 1 were foamed at 25° C. according to an ordinary process to produce flexible polyurethane foams. YI (yellow index) values based on a white board of the obtained slow-yellowing flexible polyurethane foams were measured by using “ZE2000” available from Nippon Denshoku Industries Co., Ltd according to JIS (Japanese Industrial Standard) L0855.

As for the obtained flexible polyurethane foams, the fading tests were conducted by the following methods and the results are shown in Table 1. In Table 1, the slow-yellowing flexible polyurethane foam is indicated by “foam body”.

<NOₓ Fading Test>

The YI value based on a white board was measured by using “ZE2000” available from Nippon Denshoku Industries Co., Ltd according to JIS (Japanese Industrial Standard) L0855.

In the NOₓ fading test and the discoloration test as described below, the larger the difference between the YI value of the foam body and the YI value after the test is, the bigger the degree of discoloration is. In either test, the difference between the YI value of the foam body and the YI value after the test is desired to be 60 or less, preferably 50 or less, more preferably 30 or less, and most preferably 20 or less.

<Fading Test>

Each flexible polyurethane foam (foam body) was irradiated with ultraviolet ray for 5 hours by a fadeometer having one carbon arc lump and, after that, the YI value based on a white board was measured by using “ZE2000” available from Nippon Denshoku Industries Co., Ltd.

<Heat Fading Test>

Each slow-yellowing flexible polyurethane foam (foam body) was held at 120° C. for 2 hours and, after that, the YI value based on a white board was measured by using “ZE2000” available from Nippon Denshoku Industries Co., Ltd.

<Humidity and Heat Fading Test>

Each slow-yellowing flexible polyurethane foam (foam body) was held at 70° C. and at a humidity of 95 RH % for 35 days and, after that, the YI value based on a white board was measured by using “ZE2000” available from Nippon Denshoku Industries Co., Ltd.

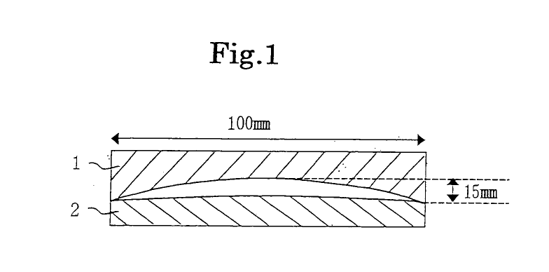

A block of 100 mm×100 mm×15 mm prepared from each slow-yellowing flexible polyurethane foam (foam body) was hot-pressed at 225° C. for 70 sec. by a mold composed of an upper part 1 and a lower part 2 having configurations and sizes shown in FIG. 1 into a hot pressed product (brassiere pad). As for the hot pressed product, the NOₓ test, fading test, heat fading test, and humidity and heat fading test as mentioned above were conducted. The results are shown in Table 1.

In addition, it is also examined whether it is possible to form a hot pressed product having a shape enough for use as a brassiere pad when a block of 100 mm×100 mm×15 mm prepared from each slow-yellowing flexible polyurethane foam (foam body same as the above) was hot-pressed at lower temperature and for shorter period of time. It was found from this examination that each foam could stand at a temperature and for a period of time shown in a section of “Reference Condition” in Table 1.

TABLE 1

| | | | Comparative | Comparative |
|---|---|---|---|---|
| | | Example 1 | Example 1 | Example 2 |
| Poly- | Polyol A (*1) | 100 | | |
| urethane | Polyol B (*2) | | 100 | |
| Foam Raw | Polyol C (*3) | | | 100 |
| Material | Isocyanate (*4) | 53 | 53 | 51 |
| (part by | Water | 4 | 4 | 4 |
| weight) | Amine catalyst | 0.3 | 0.3 | 0.3 |
| | (*5) | | | |
| | Foam stabilizer | 1.5 | 1.5 | 1.5 |
| | (*6) | | | |
| | Stannous Octoate | 0.15 | 0.15 | 0.15 |
| | (*7) | | | |
| | Isocyanate Index | 108 | 108 | 109 |
| Foam | Initial Value | −5.67 | −5.47 | −5.55 |
| Body | NO_{X} Fading Test | 12.5 | 63.5 | 68.3 |
| | Fading Test | 19 | 20 | 21 |
| | Heat Fading Test | −3.58 | 0.23 | −3.01 |
| | Humidity and | 15.11 | 25.76 | 25.84 |
| | Heat Fading Test | | | |
| Hot | Pressed Product | −0.89 | 0.27 | 1.06 |
| Pressed | NO_{X} Fading Test | 25.3 | 81.5 | 85.3 |
| Product | Fading Test | 32.2 | 35.4 | 36.0 |
| | Heat Fading Test | 1.58 | 5.87 | 1.74 |
| | Humidity and | 25.18 | 37.55 | 36.51 |
| | Heat Fading Test | | | |

| | | | |
|---|---|---|---|
| Reference Condition | 205° C. × 60 | 215° C. × 70 | 225° C. × 75 |
| | sec | sec | sec |

*1 through *7 in Table 1 are as follows:
*1: “FK134” available from Sanyo Chemical Industries, Ltd. Polyether polyol prepared by alternatively adding propylene oxide and phthalic anhydride into glycerin to have ends with propylene oxide Molar ratio between glycerin and propylene oxide: 50/50
Content of phthalic acid: 60 percent by weight
OH value = 56
Molecular Weight = 3000
*2: “3030” available from Sanyo Chemical Industries, Ltd. Polyol prepared by adding propylene oxide and ethylene oxide into glycerin
OH value = 56
Molecular Weight = 3000
*3: “FA311” available from Sanyo Chemical Industries, Ltd. Polyol prepared by adding propylene oxide and ethylene oxide into glycerin and sugar
OH value = 42
*4: “TDI80” available from Takeda Medical Industries, Ltd. Tolylene diisocyanate
*5: “33LV” available from Sankyo Airproducts Co., Ltd. Triethylene diamine
*6: “L6202” available from Shin-Etsu Chemical Co., Ltd. Silicone surfactant
*7: Available from Nihon Kagaku Sangyo Co., Ltd.

As shown in Table 1, according to the present invention, both the slow-yellowing flexible polyurethane foam (foam body) and the hot pressed product thereof can be prevented from being discolored.

### INDUSTRIAL APPLICABILITY

As described above, according to the present invention, a slow-yellowing flexible polyurethane foam which is free from problems of yellowing the foam itself and color migration due to the yellowing can be manufactured at cheaper cost.

The slow-yellowing flexible polyurethane foam of the present invention is useful as pads for clothing-related uses such as brassiere pads, material for sanitary goods such as disposable diapers and napkins, and material for medical-related goods and miscellaneous goods. Therefore, high-quality products having high commercial value and which are free from problems of deterioration and defect in appearance due to yellowing can be manufactured at cheaper cost.

What is claimed is:

1. A slow-yellowing flexible polyurethane foam which is made by foaming a polyurethane raw material containing a polyol component and an isocyanate, wherein the polyol component contains a polyether polyol having ester bonds in the polyol backbone.

2. A slow-yellowing flexible polyurethane foam which is made by foaming a polyurethane raw material containing a polyol component and an isocyanate, wherein the polyol component contains a polyether polyol having a plurality of benzene rings in the polyol structure.

3. A slow-yellowing flexible polyurethane foam which is made by foaming a polyurethane raw material containing a polyol component and an isocyanate, wherein the polyol component contains a polyether polyol having ester bonds in the polyol backbone and having a plurality of benzene rings in the polyol structure.

4. A slow-yellowing flexible polyurethane foam as claimed in claim 3, wherein the polyether polyol is a phthalic acid-based polyether polyol.

5. A slow-yellowing flexible polyurethane foam as claimed in any one of claims 1 through 4, wherein the polyol component contains a non-volatile antioxidant having a molecular weight of 300 or more.

6. A slow-yellowing flexible polyurethane foam as claimed in any one of claims 1 through 5, wherein the polyurethane raw material contains an ultraviolet absorbent and/or an anti-NOₓ agent.

7. A pad made of a slow-yellowing flexible polyurethane foam as claimed in any one of claims 1 through 6.

8. A brassiere pad made of a slow-yellowing flexible polyurethane foam as claimed in any one of claims 1 through 6.
